(19) United States
(12) Patent Application Publication
(10) Pub. No.: US 2012/0319410 A1
(43) Pub. Date: Dec. 20, 2012

(54) SYSTEM AND METHOD FOR THERMAL ENERGY STORAGE AND POWER GENERATION

(75) Inventors: James W. Ambrosek, Fort Collins, CO (US); Mark H. Anderson, Madison, WI (US); Paul Brooks, Fitchburg, WI (US); Michael B. Riley, Fort Collins, CO (US); Greg W. Field, Loveland, CO (US); Kamran Eftekhari Shahroudi, Fort Collins, CO (US); Richard JJ Nelen, Fort Collins, CO (US); Thomas A. Gendron, Fort Collins, CO (US); Gary F. Kaiser, Fort Collins, CO (US)

(73) Assignee: Woodward Governor Company, Fort Collins, CO (US)

(21) Appl. No.: 13/163,081

(22) Filed: Jun. 17, 2011

(51) Int. Cl. H02K 7/18

(52) U.S. Cl. 290/1 R

(57) ABSTRACT

A thermal energy storage system is proposed in which the latent heat of fusion of common salts is used to store energy within a selectable temperature range, extending both above and below the melting/freezing temperature zone of the salt mixture. The salt mixture occupies interstitial void spaces in a solid endostructure. The solid material remains in the solid state throughout the thermal cycling of the energy storage system, and preferably has properties of thermal conduction and specific heat that enhance the behavior of the salt mixture alone, while being chemically compatible with all materials in the storage system. The storage system is capable of accepting and delivering heat at high rates, thereby allowing power generation using a suitable energy transfer media to power a turbine of an electric generator or a process heat need to provide a relatively local, dispatchable, rechargeable thermal storage system, combined with a suitably sized generator.

### BACKGROUND OF THE INVENTION

With the increasing integration of renewable generation and the resulting stress on grid reliability, new, low cost, robust methods are needed to store power for buffering excess off-peak generation and balancing of electrical supply and demand. Presently, fossil fuel resources are ramped up and down to balance the variability of wind and solar generation, resulting in increased emissions and reduced reliability of equipment. Pumped hydroelectric storage is an example of the ability to charge a storage system during off-peak operation, and maintain availability to produce peak power on demand. Unfortunately, there are not sufficient pumped hydro sites available to relieve grid congestion and the ramp-up time required for such systems is substantial. Battery technologies are being demonstrated, however costs are high and reliability is untested over long periods.

Prior implementations of Thermal Energy Storage (TES) have seen limited success. For grid scale, TES has seen limited application, and primarily for direct application in concentrated solar power (CSP) utilizing very large storage vessels of molten salt. In this application, heat from the CSP collector is transferred to liquid phase salt and pumped to a large tank to store solar heat for later usage, where it is then pumped through a heat exchanger for energy extraction and to a low temperature second tank. To date, most commercial systems have imposed temperature limits below 350 degrees C. due to the desire to use low vapor pressure synthetic oils for heat transfer fluids. The salts used have typically been mixtures of sodium and potassium nitrates. These single-phase, molten salts have typically been designed to have a low melting point because they require pumping through closed loop systems and failure modes often involve solidification of the molten salt within the system, resulting in significant effort to re-liquefy the entire heat transfer circuit upon restart.

### SUMMARY OF THE INVENTION

An embodiment of the present invention may therefore comprise: a system that stores thermal energy and provides electrical output comprising: a thermal energy storage module comprising: an insulated containment vessel; a source energy input in thermal communication with a thermal energy storage media and a thermal conductive endostructure, the thermal conductive endo structure that absorbs heat energy from the source energy and conducts the heat energy throughout the thermal conductive endostructure in a first time period, the thermal energy storage media that absorbs heat energy from the source energy and the thermal conductive endostructure to produce a phase change in the thermal energy storage media and store the heat energy as sensible heat and latent heat in a liquid form in the first time period; and, a heat exchanger in thermal communication with the thermal energy storage media and the thermal conductive endostructure that transfers stored thermal energy in the form of sensible heat from the thermal conductive endostructure to an energy transfer media in a second time period, the thermal energy storage media that transfers stored thermal energy in the form of latent heat from the phase change of the thermal energy storage media, and sensible heat from the thermal energy storage media, to the energy transfer media in the second time period; a stored energy output in thermal communication with the energy transfer media that facilitates transport of the energy transfer media from the insulated containment vessel to a turbine, the turbine that converts the heat energy from the energy transfer media into work and exhaust; a generator in mechanical communication with the turbine that utilizes the work to provide electricity in the second time period; and, a recuperator in thermal communication with the exhaust that extracts waste heat from the exhaust to preheat the energy transfer media before returning the energy transfer media to the source energy input.

An embodiment of the present invention may also comprise: a system that stores thermal energy and provides electrical output comprising: a primary thermal energy storage module comprising: a first insulated containment vessel; a first source energy input in thermal communication with a first thermal energy storage media and a first thermal conductive endostructure, the first thermal conductive endostructure that absorbs heat energy from the first source energy and conducts the heat energy throughout the first thermal conductive endostructure in a first time period, the first thermal energy storage media that absorbs heat energy from the first source energy and the first thermal conductive endostructure to produce a phase change in the first thermal energy storage media and store the heat energy as sensible heat and latent heat in a liquid form in the first time period; and, a first heat exchanger in thermal communication with the first thermal energy storage media and the first thermal conductive endostructure that transfers stored thermal energy in the form of sensible heat from the first thermal conductive endostructure to a first energy transfer media in a second time period, the first thermal energy storage media that transfers stored thermal energy in the form of latent heat from the phase change of the first thermal energy storage media, and sensible heat from the first thermal energy storage media, to the first energy transfer media in the second time period; a stored energy output in thermal communication with the energy transfer media that facilitates transport of the energy transfer media from the primary thermal energy storage module to a high pressure turbine, the high pressure turbine that converts the heat energy from the energy transfer media into primary work and primary exhaust; a secondary thermal energy storage module comprising: a second insulated containment vessel; a second source energy input in thermal communication with a second thermal energy storage media and a second thermal conductive endostructure, the second thermal conductive endostructure that absorbs heat energy from the primary exhaust and conducts the heat energy throughout the second thermal conductive endostructure in a first time period, the second thermal energy storage media that absorbs heat energy from the primary exhaust and the second thermal conductive endostructure to produce a phase change in the second thermal energy storage media and store the heat energy as sensible heat and latent heat in a liquid form in the first time period; and, a second heat exchanger in thermal communication with the second thermal energy storage media and the second thermal conductive endostructure that transfers stored thermal energy in the form of sensible heat from the second thermal conductive endostructure to a second energy transfer media in a second time period, the second thermal energy storage media that transfers stored thermal energy in the form of latent heat from the phase change of the second thermal energy storage media, and sensible heat from the second thermal energy storage media, to the second energy transfer media in the second time period; a second stored energy output in thermal communication with the energy transfer media that facilitates transport of the energy transfer media from the secondary thermal energy storage module to a low pressure turbine, the low pressure turbine that converts the heat energy from the energy transfer media into secondary work and secondary exhaust; a generator in mechanical communication with the high pressure turbine and low pressure turbine that utilizes the primary work and the secondary work to provide electricity in the second time period; and, a recuperator in thermal communication with the secondary exhaust that extracts waste heat from the secondary exhaust to preheat the energy transfer media before returning the energy transfer media to the source energy input.

An embodiment of the present invention may therefore comprise: a method of storing thermal energy and providing electrical energy output comprising the steps of: during a first time period; transferring thermal energy within an insulated containment vessel from a heat source to a thermal conductive endostructure and a thermal energy storage media; absorbing and conducting the thermal energy from the heat source throughout the thermal conductive endostructure; absorbing the thermal energy from the heat source and the thermal conductive endostructure with a thermal storage media; changing the phase of the thermal storage media from solid to liquid with the thermal energy; and, storing the thermal energy in the form of sensible heat in the thermal conductive endostructure, and storing the thermal energy in the form of sensible heat and latent heat in the liquefied thermal storage media; during a second time period; transferring the stored thermal energy in the form of sensible heat from the thermal conductive endostructure through a heat exchanger to an energy transfer media; transferring the stored thermal energy in the form of latent heat from the phase change of the thermal energy storage media, and sensible heat from the thermal energy storage media through the heat exchanger to the energy transfer media; transferring thermal energy with the energy transfer media from the insulated containment vessel to a turbine; converting the thermal energy from the energy transfer media into work and exhaust; utilizing the work to provide electricity with a generator in mechanical communication with the turbine; extracting waste heat from the exhaust with a recuperator; preheating the energy transfer media with the extracted waste heat in the recuperator; and, returning the energy transfer media to the insulated containment vessel.

An embodiment of the present invention may also comprise: a system for storing thermal energy and providing electrical energy output comprising: during a first time period; a means for transferring thermal energy within an insulated containment vessel from a heat source to a thermal conductive endostructure and a thermal energy storage media; a means for absorbing and conducting the thermal energy from the heat source throughout the thermal conductive endostructure; a means for absorbing the thermal energy from the heat source and the thermal conductive endostructure with a thermal storage media; a means for changing the phase of the thermal storage media from solid to liquid with the thermal energy; and, a means for storing the thermal energy in the form of sensible heat in the thermal conductive endostructure, and storing the thermal energy in the form of sensible heat and latent heat in the liquefied thermal storage media; during a second time period; a means for transferring the stored thermal energy in the form of sensible heat from the thermal conductive endostructure through a heat exchanger to an energy transfer media; a means for transferring the stored thermal energy in the form of latent heat from the phase change of the thermal energy storage media, and sensible heat from the thermal energy storage media through the heat exchanger to the energy transfer media; a means for transferring thermal energy with the energy transfer media from the insulated containment vessel to a turbine; a means for converting the thermal energy from the energy transfer media into work and exhaust; a means for utilizing the work to provide electricity with a generator in mechanical communication with the turbine; a means for extracting waste heat from the exhaust with a recuperator; a means for preheating the energy transfer media with the extracted waste heat in the recuperator; and, a means for returning the energy transfer media to the insulated containment vessel.

### BRIEF DESCRIPTION OF THE DRAWINGS

In the drawings,

FIG. 1 illustrates an embodiment of a system for storing thermal energy storage and later utilizing this stored energy to generate power with a steam turbine generator.

FIG. 2 illustrates another embodiment of a system for storing thermal energy storage and later utilizing this stored energy to generate power with an air turbine generator.

FIG. 3 illustrates another embodiment of a system for storing thermal energy storage and later utilizing this stored energy to generate power with a supercritical CO₂ turbine generator.

FIG. 4 illustrates a configuration of an embodiment of a system for storing thermal energy for later use.

FIG. 5 illustrates an embodiment of a system for enhancing the thermal conductivity of a phase change thermal energy storing media.

FIG. 6 illustrates another embodiment of a system for enhancing the thermal conductivity of a phase change thermal energy storing media.

FIG. 7 illustrates an exemplary graphical depiction of a phase/formulation diagram for a typical phase change media for use in thermal energy storage.

### DETAILED DESCRIPTION OF THE INVENTION

While this invention is susceptible to embodiment in many different forms, it is shown in the drawings, and will be described herein in detail, specific embodiments thereof with the understanding that the present disclosure is to be considered as an exemplification of the principles of the invention and is not to be limited to the specific embodiments described.

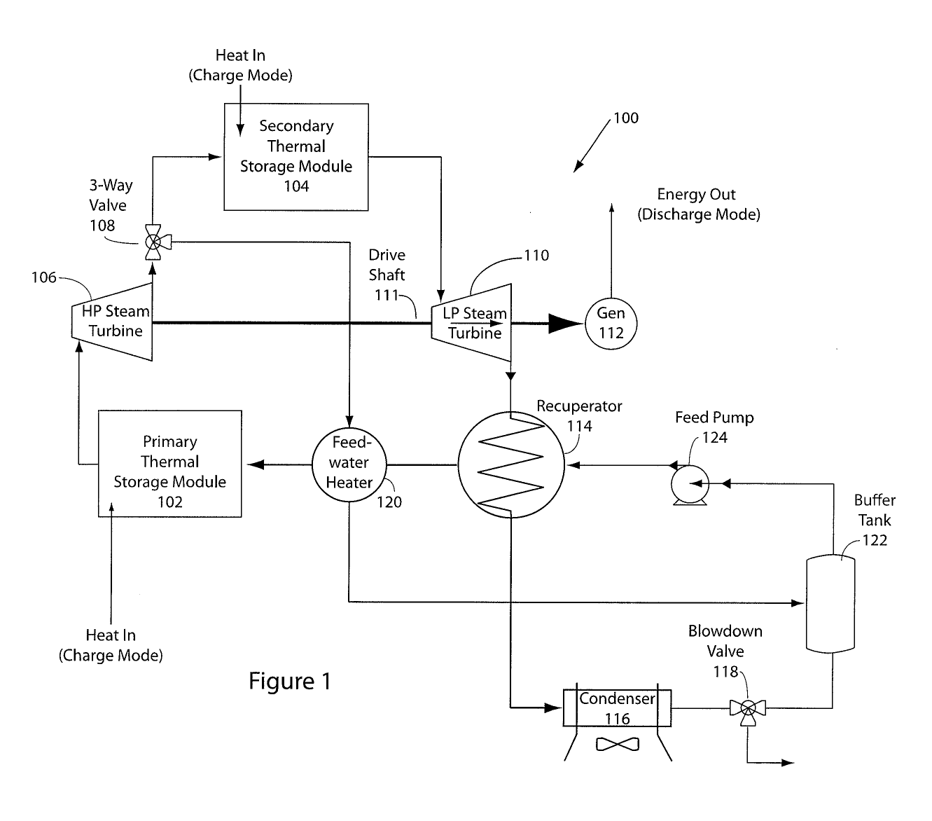

FIG. 1 illustrates an embodiment of a system for storing thermal energy storage and later utilizing this stored energy to generate power with a steam turbine generator. The exemplary embodiment of the steam turbine TES system 100 depicted in FIG. 1, provides a system that stores thermal energy utilizing materials of various specific heats and latent heats of fusion, and melting/freezing temperature ranges across a temperature range that is advantageous for providing turbine driven power generation while being able to “charge” (bring the TES media to maximum operational temperature) within a short specified period. Additionally, the system allows for extraction of heat via heat transfer fluid in an internal heat transfer loop, without having to pump the salt, and to discharge the TES media from its fully charged state, to its minimally charged state, within a short specified period.

In this embodiment, a typical Rankine steam power cycle is utilized to convert heat into work. Conditions given below might yield a power output of approximately 1 MW. The system as shown, utilizes a feed pump 124, which draws cool liquid-phase water from a buffer tank 122 and pumps it up to high pressure (i.e., 13.7 MPa at about 1 kg/sec flow), which is then fed to a recuperator 114 where it picks up waste heat from the outlet of the low-pressure steam turbine 110 and is fed into the primary thermal storage module 102. The primary thermal storage module 102 will be detailed below but has been pre-charged to retain heat from an external source and now exchanges this heat to the incoming water. This water is heated in the primary thermal storage module 102 to approximately 530 degrees C. thereby producing extremely high-temperature, high-pressure (13 MPa) steam that is delivered to the high-pressure steam turbine 106, which converts the heat and pressure of the superheated fluid into work, turning the drive shaft 111, which drives a generator 112 to produce electricity. This generator may produce AC or DC electricity for direct on-demand use or may be imparted back into an electric power grid. Lower pressure, lower temperature exhaust exits the high-pressure steam turbine 106 and flows to a three-way valve 108 where a portion of this high-pressure exhaust can be diverted to the feedwater heater 120, and exchange heat with the incoming feedwater to raise its temperature as it enters the primary thermal storage module 102. Upon heat exchange with the feedwater in the feedwater heater 120, the cooled exhaust stream (now in liquid phase) is transferred to the buffer tank 122 for storage and reuse.

The portion of the high-pressure exhaust that is not diverted by the three-way valve 106 to the feedwater heater 120, is reheated by the secondary thermal storage module 104, which, as was the case with the primary thermal storage module 102, has been pre-charged to retain heat from an external source and now exchanges this heat to the exhaust of the high-pressure steam turbine 106 to again form a high-temperature, medium-pressure (289 kPa) steam that is injected into the low-pressure steam turbine 110, which also converts the heat and pressure of the superheated fluid to work, turning the drive shaft 111. Lower pressure, lower temperature exhaust exits the low-pressure steam turbine 110 and flows into the recuperator 114, where waste heat is drawn from the low-temperature, low-pressure exhaust and used to preheat the incoming feedwater being pumped from the feed pump 124 to the feedwater heater 120. After this heat exchange with the feedwater, lower temperature exhaust is cooled and condensed in the condenser 116, where heat is typically rejected convectively to the ambient air. Cool, liquid-phase water exits the condenser and passes through a blowdown valve 118 (used for system charging and maintenance) and is returned to the buffer tank 122 for storage and reuse. Thus, a complete Rankine power cycle is realized and repeated, on-demand, throughout the thermal storage capacity of the system.

The embodiment shown in FIG. 1 is depicted with two distinct and independent thermal storage modules, the primary thermal storage module 102, and the secondary thermal storage module 104. It is also contemplated within the scope of the disclosure, that a single thermal storage module may be utilized to combine the heat storage and output functions. In this manner, the lower pressure, lower temperature exhaust exiting the high-pressure steam turbine 106 may be returned by the three-way valve 108 back to the same single thermal storage module, where the low-temperature exit stream is reheated to produce a high-temperature, medium-pressure (289 kPa) steam that is delivered to the low-pressure steam turbine 110 which also converts the heat and pressure of the superheated fluid to work, turning the drive shaft 111.

The aforementioned embodiment facilitates the conversion of energy into stored energy (e.g., from kilowatt-hours to many megawatt-hours) at power rates from kilowatts to megawatts that may be input in a variety of forms, and from a wide variety of sources. For instance, the input energy may be in the form of electricity (AC or DC that drives electric resistance heaters) that produces heat, which is stored within the thermal storage module(s) 102,104 in one embodiment. In another embodiment, additional energy sources such as solar, wind, geothermal, hydro, fuel cells, nuclear, or the like, may be input into the thermal storage module(s) 102, 104 as the source of heat-in. Similarly, the output power of the system depicted in FIG. 1 may also be in another form besides AC electricity. Hot fluid over a range of pressures may be extracted from the system to provide heating, or the power may be converted into any number of forms to be utilized directly.

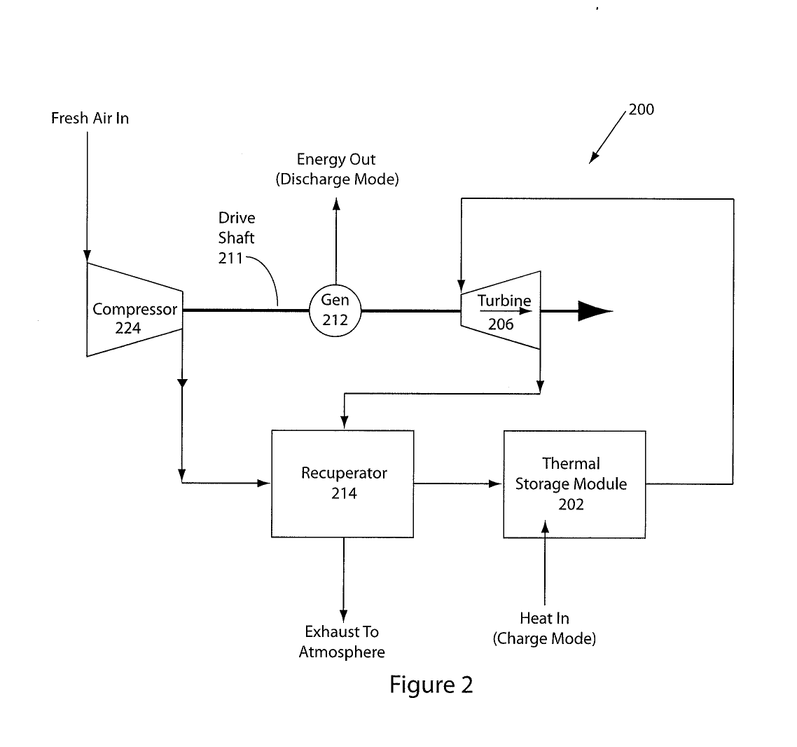

FIG. 2 illustrates another embodiment of a system for using thermal energy storage and later utilizing this stored energy to generate power with a gas turbine generator. The exemplary embodiment of the compressed air turbine TES system 200 depicted in FIG. 2, also provides a system that stores thermal energy utilizing materials of various specific heats and latent heats of fusion, and melting/freezing temperature ranges across a temperature range that is advantageous for providing turbine-driven power generation while being able to “charge” (bring the TES media to maximum operational temperature) within a short specified period. Like the embodiment that was detailed in FIG. 1, the system of FIG. 2 allows for extraction of heat via heat transfer fluid in an internal heat transfer loop, without having to pump the salt, and to discharge the TES media from it's fully charged state, to its minimally charged state, within a short specified period.

In this embodiment, a typical Brayton thermodynamic cycle utilizes a gas turbine generator to convert heat into work. The system, under the conditions given below, and disclosed as shown in FIG. 2, may yield a power output of approximately 1 MW utilizing a compressor 224, which draws fresh ambient air in, and compresses it to approximately 300 kPa. In doing so, the air is heated from the compression to about 300 degrees C. and flows at approximately

6.8 kg/sec. The compressed air flows into a recuperator 214, where it picks up waste heat extracted from the exhaust of gas turbine 206 where the gas temperature is raised to about 564 degrees C. and fed into the thermal storage module 202. The thermal storage module 202 will be detailed below, but has been pre-charged to retain heat from an external source, and now exchanges this heat to the incoming preheated compressed air. This compressed air is heated in the thermal storage module 202 to approximately 927 degrees C., thereby producing extremely high-temperature, low-pressure air that is delivered to the gas turbine 206, which converts the heat and pressure of the heated air into work, turning the drive shaft 211, which is used to drive the compressor 224 and a generator 212 to produce electricity. This generator may produce AC or DC electricity for direct on-demand use or may be imparted back into an electric power grid.

Lower pressure, lower temperature exhaust exits the gas turbine 206 and flows into the recuperator 214, where waste heat is drawn from the lower temperature, lower pressure exhaust and used to preheat the incoming compressed air being pumped from the compressor 224 to the thermal storage module 202. After this heat exchange with the compressed air, lower temperature exhaust is ejected to the atmosphere at roughly 250 degrees C. This waste heat may also be used as an additional source of energy for any secondary heating demands. Thus, a complete Brayton power cycle is realized and repeated, on-demand, throughout the thermal storage capacity of the system. As with the embodiment of FIG. 1, the aforementioned embodiment may facilitate the energy conversion of many kilowatt-hours to megawatt-hours into storage at a multi-kilowatt to multi-megawatt power rates that may be input in a variety of forms, and from a wide variety of sources.

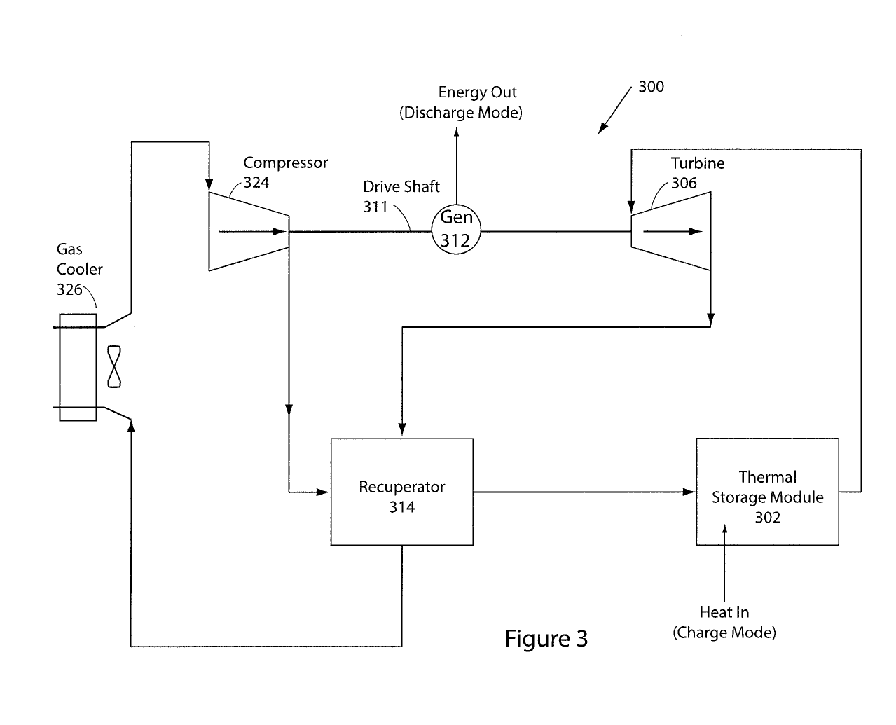

FIG. 3 illustrates yet another embodiment of a system for storing thermal energy storage and later utilizing this stored energy to generate power with a compressed gas turbine generator. The exemplary embodiment of the compressed gas turbine TES system 300 that is depicted in FIG. 3 also provides a system that stores thermal energy, utilizing materials of various specific heats, latent heats of fusion, and melting/freezing temperature ranges across a temperature range that is advantageous for providing turbine driven power generation. This is accomplished while being able to “charge” (bring the TES media to maximum operational temperature) within a short specified period. Like the embodiments that were detailed in FIGS. 1 and 2, the system of FIG. 3 allows for extraction of heat via heat transfer fluid in an internal heat transfer loop, without having to pump the salt. With this embodiment, the TES media is discharged from its fully charged state, to its minimally charged state, within a short specified period.

As was similarly described in the embodiment of FIG. 2, the embodiment of FIG. 3 depicts a Brayton thermodynamic cycle, but now of closed loop design, utilizing a gas turbine generator to convert heat into work. Conditions given below may yield a power output of approximately 1 MW but the system is highly scalable. The system, as shown in FIG. 3, utilizes a gas cooler 326 filled with a high-pressure gas, such as supercritical carbon dioxide (CO₂) or helium. In the case of supercritical CO₂ the CO₂ is fed at approximately 7.5 MPa and 31 degrees C. into compressor 324, at a flow rate of about 8.6 kg/sec. The CO₂ is compressed to approximately 22.5 MPa. In doing so, the CO₂ is heated from the compression to about 170 degrees C. The compressed CO₂ flows into a recuperator 314, where it picks up waste heat extracted from the exhaust of gas turbine 306 where the gas temperature is raised to about 464 degrees C. and fed into the thermal storage module 302. The thermal storage module 302 will be detailed below, but has been pre-charged to retain heat from an external source and now exchanges this heat to the incoming preheated compressed CO₂. This compressed CO₂ is heated in the thermal storage module 302 to approximately 700 degrees C., thereby producing extremely high-temperature, high-pressure CO₂ that is delivered to the gas turbine 306, which converts the heat and pressure of the superheated CO₂ into work by turning the drive shaft 311, which is used to drive the compressor 324 and a generator 312 to produce electricity. This generator may produce AC or DC electricity for direct on-demand use or may be imparted back into an electric power grid. Additionally the aforementioned systems may utilize additional energy output forms depending upon the specific application of the system. For example, the generators 112, 212 and 312 may be replaced by another machine that may utilize the work output of the turbines 106, 110, 206 and 306 such as a mill or the like. It is also contemplated within the scope of the invention that the heat output of the of the thermal energy storage modules 102, 104, 202 and 302 may be utilized directly to provide heat, such as environmental heating, commercial and industrial process heating applications or the like.

Lower pressure, lower temperature exhaust exits the gas turbine 306 and flows into the recuperator 314, where waste heat is drawn from the low-temperature, low-pressure CO₂ exhaust and used to preheat the incoming compressed CO₂ being pumped from the compressor 324 to the thermal storage module 302. After this heat exchange with the compressed CO₂, lower temperature exhaust CO₂ exits the recuperator 314 at roughly 200 degrees C. and fed into the gas cooler 326, where it is cooled to approximately 31 degrees C. Thus, a complete Brayton power cycle is realized and repeated, on-demand, throughout the thermal storage capacity of the system. As with the embodiment of FIGS. 1 and 2, the aforementioned embodiment facilitates the energy conversion of many kilowatt-hours to megawatt-hours into storage at a multi-kilowatt to multi-megawatt power rates that may be input in a variety of forms, and from a wide variety of sources.

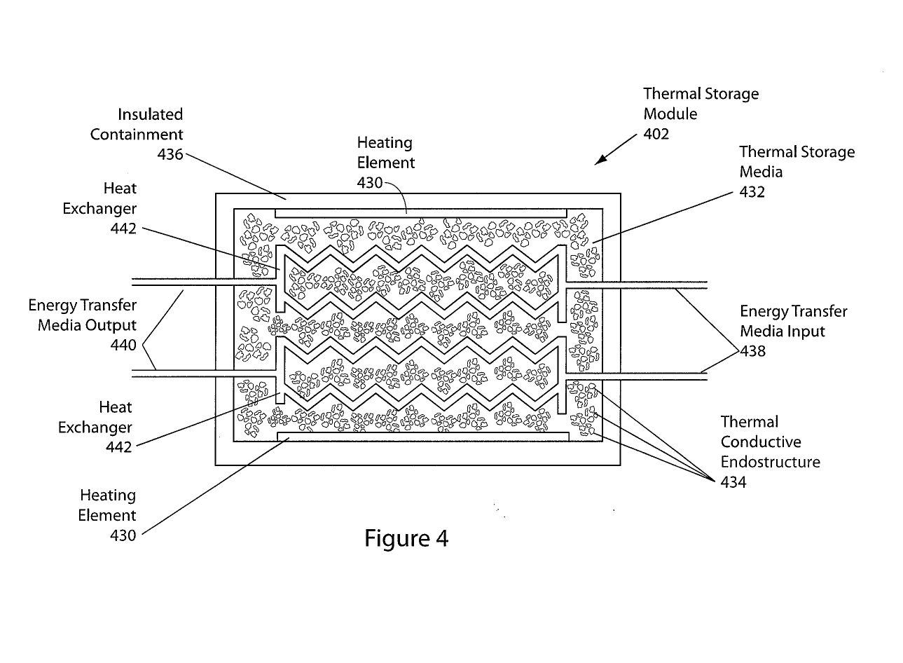

FIG. 4 illustrates a configuration of an embodiment of a system for storing thermal energy for later use. As shown in FIG. 4, a thermal storage module 402, such as utilized in the aforementioned embodiments (102, 104, 202 and 302), facilitates the storage and conversion (if necessary) of source energy for later use. This storage is performed with a phase change thermal storage media 432 to greatly increase the heat (storage) capacity of the module, but in this embodiment the thermal storage media 432 is not actively circulated to transport thermal energy from place to place, as is utilized with many solar applications. In a typical CSP application, liquid phase, and only liquid phase salt, is used as the thermal storage medium which is pumped from storage tanks of varying temperature to store solar heat for later usage. In these applications, phase change of the storage media is not utilized for its latent heat capacity, and the salts do not change phase at any time during operation. These applications require low melting point salts so that pumping through closed loop systems can be accommodated with lower risk of freezing. Failure modes that result in solidification of the molten salt within the system can result in significant effort to re-liquefy the entire heat transfer circuit upon restart.

The thermal storage module shown in FIG. 4 contains a thermal storage media 432, which is in this example, a mixture of sodium chloride and magnesium chloride. This salt mixture is low cost, has a high latent and sensible heat capacity, is stable at high temperature, and does not cause corrosion problems with the material it contacts. In this embodiment, the melting point of the thermal storage media 432 should be no more than 30 degrees C. below the steam outlet temperature (i.e., 500 to 530 degrees C.), which is all accomplished with a mixture of approximately 0.7 mole fraction NaCl to 0.3 mole fraction MgCl₂. This salt mixture has a latent heat capacity of 408 kJ/kg, thereby allowing a great amount of heat to be stored within a manageably sized module. Because the present embodiment utilizes high melting point thermal storage media 432 that is undergoing phase change in the normal course of charge and discharge in order to increase efficiency and provide fluids that have the energy to drive large turbine generators, the thermal conductivity of the solid phase salt becomes an issue. Since solid phase salt mixtures are typically thermal insulators, the transmittance of thermal energy into the solid thermal storage media 432 is enhanced with a thermal conductive endostructure 434, which is interstitial with the thermal storage media 432. This thermal conductive endostructure 434 forms pathways of thermal communication throughout the thermal storage media 432, and facilitates thermal conduction that may then support thermal convection to provide more efficient and rapid heat transfer from the heat-in source, which in this embodiment are electric heating elements 430, throughout the thermal storage media 432.

There is considerable flexibility with the number and geometry of heaters (electric heating elements 430) required to deliver the amount of thermal power needed to raise the temperature of the thermal storage media 432 to its fully charged state within a specified period. These heater segments may need to be controlled separately depending on the temperature distribution existing in the storage system after a thermal extraction has taken place. The combination of limited convection, due to the solid filler material in which the thermal storage media 432 is held, and lengthwise movement of the energy transfer media will tend to create a thermal wave that travels the length of the vessel. If the thermal extraction is halted prior to complete discharge of the storage vessel, a portion of the thermal storage module 402 nearer the energy transfer media output 440 may still be at an elevated temperature, still near its “full” thermal capacity. In this case, the heaters near this section will probably not be necessary for thermal recharge. However, the heaters nearer the energy transfer media input 438 will likely be necessary to recharge the now-cool thermal storage media 432 and thermal conductive endostructure 434.

Typically, a rectangular storage vessel geometry with horizontal movement of a heat extraction fluid would likely be unable to maintain a strong thermal boundary between an area of discharge and another area that is thermally charged if the liquid salt supported free convection cells. For a thermal storage media 432, whose density varied with temperature (such as a tank of molten salt without filler), the effects of thermal buoyancy would likely cause rapid mixing to negate such a thermocline. However, the addition of the thermal conductive endostructure 434 includes interstitial voids whose size limits the effects of convection. This thermal storage module 402 may be utilized in any of the aforementioned embodiments (FIGS. 1-3) and is adaptable to specific temperature output capabilities by minor changes in geometry or more particularly by adjusting the thermal storage media 432. For example, the aforementioned 70/30 NaCl—MgCl₂ mixture, used in steam-driven power generation, may be adjusted to increase or decrease the melting point of the thermal storage media 432 to adapt and optimize the type of power generation or energy transfer media (e.g., air, supercritical CO₂, helium, nitrogen or the like). Specific energy output applications may benefit from a thermal storage media 432 whose phase transitions are customized to the specific energy output of the system. For example, for a steam turbine AC output system as illustrated in FIG. 1, may benefit from the aforementioned 70/30 NaCl—MgCl₂ mixture, whereas, a gas turbine system such as illustrated in FIG. 2, may benefit from a single salt component such as Na₂CO₃, BaCl₂, or NaCl, and a closed-cycle compressed gas turbine generator such as illustrated in FIG. 3, may benefit from the 80/20 NaCl—MgCl₂ mixture or other phase change materials such as (Na₂CO₃—K₂CO₃, Li₂CO₃, NaCl—KCl.)

Because this embodiment is highly versatile, various types of thermal energy delivery (heat-in) into the above thermal storage module 402 may include, but are not limited by way of example to, resistance heating units, either on the outside of the storage vessel, or contained within the storage vessel (as embodied in FIG. 4 and shown as heating elements 430); inductive heating coils that heat a portion or all of the inductively receptive material within the container; microwave heating of receptive material within the container; circulation of steam or another heat transfer fluid through a heat transfer circuit embedded within the insulated containment 436 of the storage vessel.

The thermal conductivity of the thermal storage media 432 and thermal conductive endostructure 434, when the salt is in its solid state, will be the limiting condition for rapid addition or removal of heat to and from the thermal storage module 402. For this reason, it may be unnecessary to rely on convection circulation cells being set up within the thermal storage media 432 and thermal conductive endostructure 434 when the salt has melted, although some level of natural convection could be beneficial. The thermal conductive endostructure 434, should have good thermal conduction, chemical compatibility with the thermal storage container and internal materials (e.g., heat exchanger, etc.), and be able to maintain its heat transfer capability and structure while undergoing thermal and mechanical stresses of rapid, high temperature swings while within a thermal storage media 432 that is undergoing phase changes. Examples of such materials might be silicon carbide (typically introduced as grains, chips, granules or flakes), or stainless steel (in the form of rods, pins, cones, cubes, brushes, bristles, wire, woven or non-woven fabric, spheres, or other small shapes), which may be sufficiently small to inhibit convection, while concurrently enhancing thermal conduction.

Accordingly, the geometry of the thermal storage module may be designed around the effective thermal conductivity of the thermal storage media 432 and thermal conductive endostructure 434. Changes in this thermal conductivity would lead to alternative optimization of distances between heaters, heat exchangers, pipe diameters, etc., the density and surface area of the thermal conductive endostructure 434, storage material, and the location and distribution of the heat removal circuit embedded within the storage vessel. One embodiment for such an optimized heat exchange design, with such a thermal storage media 432 mixture and thermal conductive endostructure 434 would result in a nearly complete thermal charge or discharge during the required time interval, a measure of the thermal “fuel gauge” of the system.

Another potential advantage of a convection suppressing endostructure would be the limits the small interstitial grain sizes would impose on phase separation of the different constituents of a salt mixture. Another desirable characteristic of convection suppression would be the ability to control a thermal wave through the storage vessel without having to impose a particular orientation to compensate for gravity. Thus, the outlet temperature from the thermal storage module 402, acting as a thermal battery, could be maintained at a nearly constant temperature for a particular period of time. Additionally, the described thermal storage module 402 eliminates the need to pump molten salt through plumbed networks of pipes and tanks. If the energy transfer media is a liquid, such as water under pressure, the liquid would travel some distance before sufficient heat transfer through the salt and mixture to the pipe wall would cause the liquid to vaporize. After vaporization, the fluid would continue its path through the piping of the heat exchanger 442, increasing its temperature until it likely becomes a “dry” vapor, whose temperature equaled that of the thermal storage media 432 and the thermal conductive endostructure 434 in proximity. This dry vapor would continue through the piping until it reached the energy transfer media outlet 440 of the thermal storage module 402. From there, the vapor would be delivered to the desired load.

As the energy transfer media is being heated within the piping array of the heat exchanger 442, there would be a corresponding cooling process on the thermal storage media 432 and the thermal conductive endostructure 434 in external proximity to the piping. At the initial locations nearest the energy transfer media input 438, it is likely that the energy transfer media would start to freeze around the piping heat exchanger 442, as a crust, thinning out in the direction towards the energy transfer media outlet 440. As more heat is extracted from the thermal storage media 432 (in this example a salt mixture), the solid layer would thicken, extracting more heat from a larger distance from the heat exchanger 442. The thermal conductivity of the thermal conductive endostructure 434 would allow for larger distances between adjacent heat extraction pipes. If the thermal conductive endostructure 434, with thermal conductivity no higher than the thermal storage media 432 were utilized, then the pipes of the heat exchanger 442 might have to be so close together as to be economically and mechanically disadvantageous. For this reason, silicon carbide (SiC) is an attractive material, providing a significant enhancement in thermal conductivity, as well as being chemically inert to common salt mixtures. The material is also denser than typical salt mixtures, ensuring that it does not tend to float on top of molten salt. Thermally conductive materials with a density close to that storage media may also be used in order to promote an endostructure that is not tightly packed, and facilitates a higher proportion of media to structure (phase change to non-phase change material).

Other materials, such as stainless steel may be used, but their higher densities may benefit from shaping of the particles in order to avoid having a large mass of steel relative to the mass of the salt mixture. The addition of solid filler material in the thermal conductive endostructure 434 does act to reduce the overall thermal capacity significantly for a given volume, as the sensible heat energy capacity of such materials is significantly lower than the heat of fusion of the phase change salt mixtures. As the heat extraction process continues, a thermal wave develops, essentially depleting the initial section of the storage, and becoming a preheater for the energy transfer media progressing along the thermal storage module 402. This thermal wave continues until there is insufficient thermal energy left in the module, and the temperature of the energy transfer media at the energy transfer media outlet 440 starts to drop. At that point, the system should be considered near depletion, and a recharge cycle would be initiated.

Because the detailed embodiments utilize a stationary phase change material, the system of FIG. 4 utilizes an energy transfer media, which may be introduced as steam, air, supercritical CO₂ or the like, entering the thermal storage module 402 at the energy transfer media input 438 to heat and maintain a constant media temperature as it exits at the energy transfer media output 440. This exit temperature may be constantly maintained for an extended period of time because as the thermal battery drains, the thermal storage media 432 continues to change phase (solidify) and release heat. If this were merely a sensible storage system, like a molten salt or glycol without phase change, the temperature would drop shortly after the start of discharge, and then drop continuously greatly reducing the useful thermal range and working capacity of the thermal battery.

The thermal storage module 402 depicted in FIG. 4 may contain multiple energy transfer media circuits, and the depiction shown may be a side or top view of the module. Multiple levels of heat exchange circuits may be utilized within the scope of the embodiments to tailor performance to a specific application or capacity. Additionally, the disclosed thermal storage module 402 eliminates the need for pumping, stirring or mixing of the thermal storage media 432.

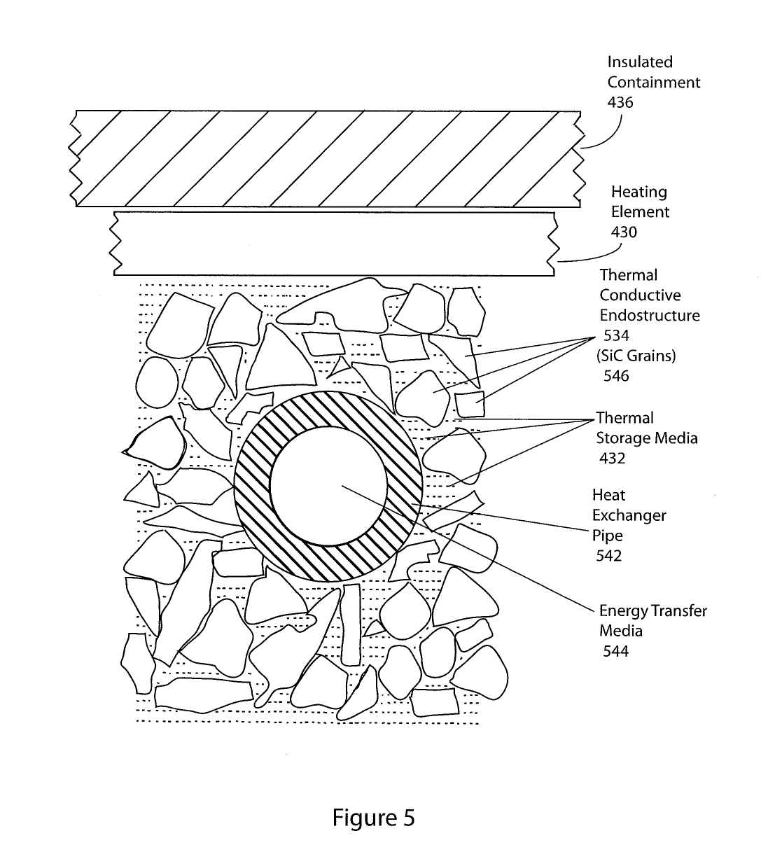

FIG. 5 illustrates an embodiment of a system for enhancing the thermal conductivity of a phase change thermal energy storing media. As shown in FIG. 5, a cross section of a thermal storage module, such as depicted in FIG. 4, contains a heat exchanger pipe 542 containing an energy transfer media 544, which might be: steam as in FIG. 1; superheated air as in FIG. 2; a gas, such as supercritical CO₂, as in FIG. 3; or any other suitable media readily known to one skilled in the art. The system would contain a plurality of such heat exchanger pipes 542, but in between these pipes would be sufficient solid material forming the thermal conductive endostructure 534, either in random granular form as shown, or more structured shapes if desired, to support its own weight. The thermal storage media 432 (in this embodiment a salt mixture) is added so that upon melting, the media occupies essentially all of the available void space. The geometry shown suggests that the energy transfer media may be a liquid, such as water, which would be turned into a vapor. A different heat transfer geometry may be likely for a gas passing through the heat exchanger pipe 542. The heating element 430, which may be located either inside or outside the insulated containment of the system, and is shown in this embodiment as being inside, transfers heat to the thermal storage media 432 and to the thermal conductive endostructure 534, which is in this instance granular silicon carbide (SiC) 546. The heating element 430 transfers heat by conduction and radiation to the thermal storage media 432 and the thermal conductive endostructure 534 in proximity to the hot surface. Heat is also transferred to the entirety of the thermal storage module 402 by conduction throughout the thermal conductive endostructure 534 and the thermal storage media 432 interstitially found within the storage module. This allows a rapid charge of the system to a desired temperature, and later a rapid discharge. The SiC grains 546 (in this example 1-2 mm grains) both store sensible heat and also transfer heat throughout the endostructure through conduction. In this manner the thermal storage media 432 is always in proximity to the conductive heat transfer of the SiC granules 546, which have a high resistance to corrosion, thereby overcoming the potential insulating properties of the thermal storage media 432.

In charge mode, the heating element 430 draws energy from a variety of forms and transfers that heat to the thermal conductive endostructure 534 and to the thermal storage media 432, heating the endostructure and changing the phase and heating the liquid media. This sensible and latent heat is contained within the thermal storage module 402 by the insulated containment 436. In discharge mode, the energy transfer media 544 flows through the heat exchanger pipe 542 and absorbs heat from the thermal conductive endostructure 534 and the thermal storage media 432. Since the cooling of the thermal storage media 432 causes phase change (solidification) to media in the proximity of the heat exchanger pipe 542, and therefore acts to insulate the pipe, latent heat continues to be transferred from the thermal storage media 432 to the heat exchanger pipe 542, via the conductive path created by the thermal conductive endostructure 534 and the storage media 432. In this manner, heat is transferred in the initial portion of the heat exchanger removing both sensible and latent heat until the storage media in close vicinity is now at or near the temperature of the fluid entering the storage vessel. As this cooling begins in the initial portion of the heat exchanger pipe 542, the next downstream portion experiences a temperature differential and transfers latent and sensible heat to the energy transfer media 544. This “thermal wave”, which starts upstream and finished downstream on the heat exchanger pipe 542 allows full discharge of the media in a rapid, efficient and complete manner, which maintains a nearly constant output temperature of the energy transfer media as it leaves the thermal storage module 402.

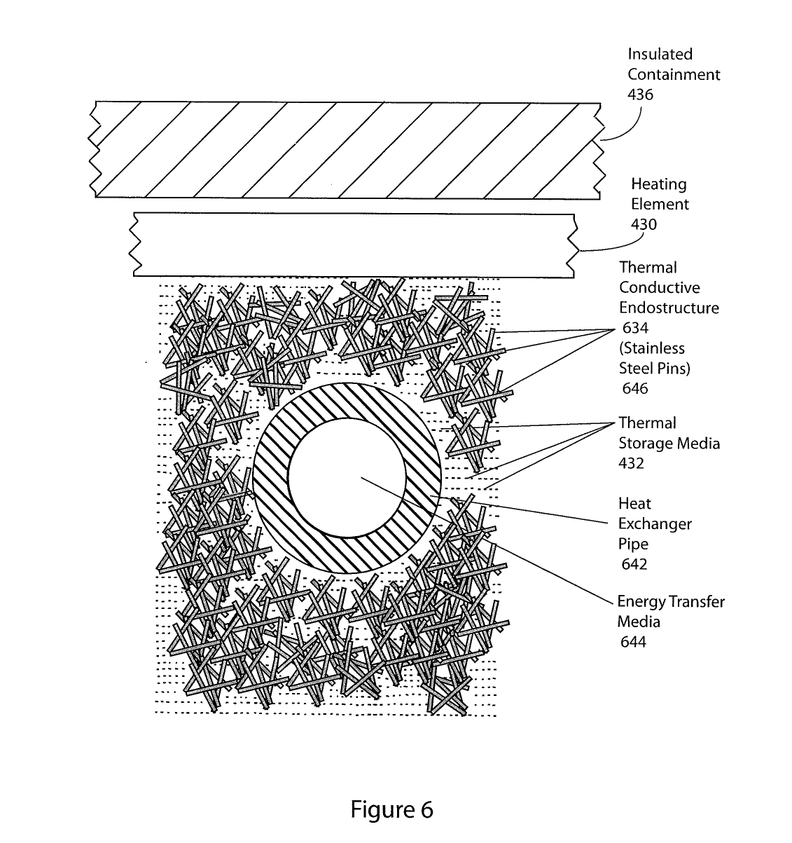

FIG. 6 illustrates another embodiment of a system for enhancing the thermal conductivity of a phase change thermal energy storing media. As was similarly shown in FIG. 5, FIG. 6 depicts a cross section of a thermal storage module that contains a heat exchanger pipe 642 containing an energy transfer media 644, which might be: steam as in FIG. 1; superheated air as in FIG. 2; a gas, such as supercritical CO₂, as in FIG. 3; or any other suitable media readily known to one skilled in the art. The heating element 430, which may be located either inside or outside the insulated containment of the system, and is shown in this embodiment as being inside, transfers heat to the thermal storage media 432 and to the thermal conductive endostructure 634, which is in this instance stainless steel rods or pins 646. The heating element 430 transfers heat by conduction and radiation to the thermal storage media 432 and the thermal conductive endostructure 634 in proximity to the hot surface. Heat is also transferred to the entirety of the thermal storage module 402 by conduction throughout the thermal conductive endostructure 634 and to the thermal storage media 432 interstitially found within the storage module. This allows a rapid charge of the system to a desired temperature, and later a rapid discharge. The stainless steel pins 646 (in this example: 316 stainless, 10 mm in length, and 1 mm in diameter) both store sensible heat with high thermal capacity and also transfer heat throughout the endostructure through conduction utilizing thermal conductivity that is higher than the salt. In this manner, the thermal storage media 432 is always in proximity to the conductive heat transfer of the stainless steel pins 646, which have a high resistance to corrosion, thereby overcoming the potential insulating properties of the thermal storage media 432. The specific geometry of the pins enhances thermal transmission along the length of the pins and increases heat exchange farther into the thermal storage media 432.

In charge mode, the heating element 430 draws energy from a variety of forms and transfers that heat to the thermal conductive endostructure 634 and to the thermal storage media 432, heating the endostructure and changing the phase and heating the liquid media. This sensible and latent heat is contained within the thermal storage module 402 by the insulated containment 436. In discharge mode, the energy transfer media 644 flows through the heat exchanger pipe 642 and absorbs heat from the thermal conductive endostructure 634 and the thermal storage media 432 (in this instance, stainless steel pins 646). As was seen in the embodiment of FIG. 5, the cooling of the thermal storage media 432 causes phase change (solidification) to media in the proximity of the heat exchanger pipe 642, and therefore, acts to insulated the pipe and transfer of latent heat continues from the thermal storage media 432 to the heat exchanger pipe 642 via the conductive path created by the thermal conductive endostructure 634. In this manner, heat is transferred in the initial portion of the heat exchanger removing both sensible and latent heat until the storage media in close vicinity is now at or near the temperature of the fluid entering the storage vessel. As this cooling begins in the initial portion of the heat exchanger pipe 642, the next downstream portion experiences a temperature differential and transfers latent and sensible heat to the energy transfer media 644. This “thermal wave”, which starts upstream and finishes downstream on the heat exchanger pipe 642, allows full discharge of the media in a rapid, efficient, and complete manner, which maintains a nearly constant output temperature of the energy transfer media as it leaves the thermal storage module 402.

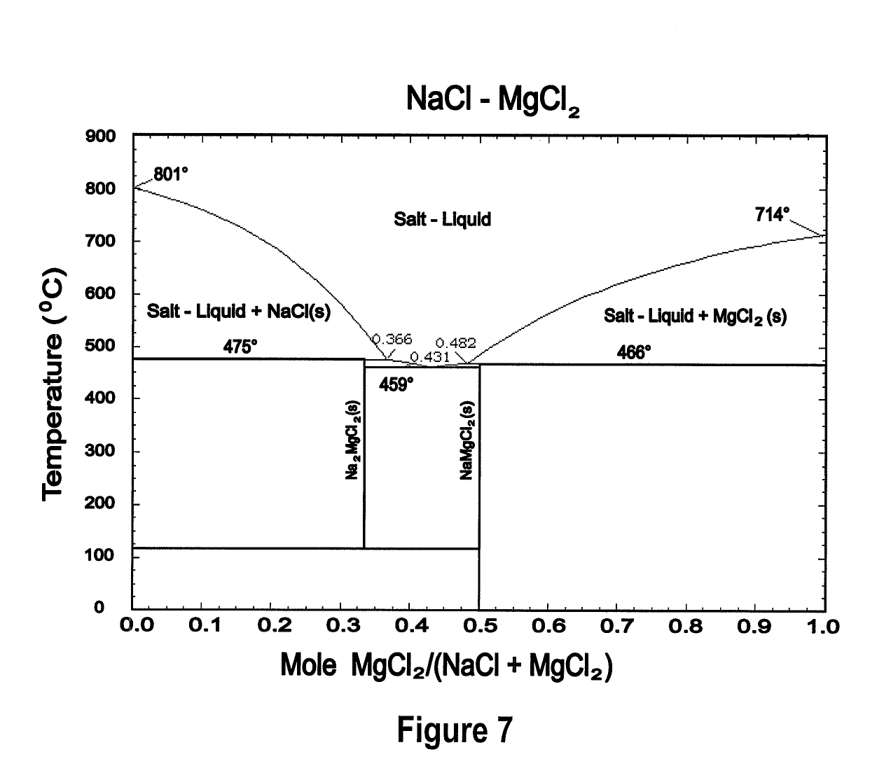

FIG. 7 illustrates an exemplary graphical depiction of a phase/formulation diagram for a typical phase change media for use in thermal energy storage. As graphically depicted in FIG. 7, the phase diagram for a thermal storage media 432, which is in this embodiment a mixture of NaCl—MgCl₂, is shown to vary with the amount of MgCl₂ to NaCl. As seen in the graph, the salt mixture at 70-30 molar % NaCl—MgCl₂, respectively, has a liquidus temperature of 560 degrees C. and a solidus temperature of 475 degrees C. However, depending on the rate of cooling, the solidus temperature may be reduced to the eutectic temperature of 450 degrees C.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A system that stores thermal energy and provides electrical output comprising:
a thermal energy storage module comprising:
an insulated containment vessel;
a source energy input in thermal communication with a thermal energy storage media and a thermal conductive matrix, said thermal conductive matrix that absorbs heat energy from said source energy and conducts said heat energy throughout said thermal conductive matrix in a first time period, said thermal energy storage media that absorbs heat energy from said source energy and said thermal conductive matrix to produce a phase change in said thermal energy storage media and store said heat energy as sensible heat and latent heat in a liquid form in said first time period; and,
a heat exchanger in thermal communication with said thermal energy storage media and said thermal conductive matrix that transfers stored thermal energy in the form of sensible heat from said thermal conductive matrix to an energy transfer media in a second time period, said thermal energy storage media that transfers stored thermal energy in the form of latent heat from the phase change of said thermal energy storage media, and sensible heat from said thermal energy storage media, to said energy transfer media in said second time period;
a stored energy output in thermal communication with said energy transfer media that facilitates transport of said energy transfer media from said insulated containment vessel to a turbine, said turbine that converts said heat energy from said energy transfer media into work and exhaust;
a generator in mechanical communication with said turbine that utilizes said work to provide electricity in said second time period; and,
a recuperator in thermal communication with said exhaust that extracts waste heat from said exhaust to preheat said energy transfer media before returning said energy transfer media to said source energy input.

2. The system of claim 1 further comprising:
a condenser located downstream of said recuperator that reduces the temperature of said energy transfer media;
a energy transfer media reservoir located downstream of said condenser;
a feed pump that pumps said energy transfer media to said thermal energy storage module via said recuperator.

3. The system of claim 2 further comprising:
a feedwater heater located between said recuperator and said thermal storage module;
a valve structure to optionally direct a portion of said energy transfer media from said thermal energy storage module to said feedwater heater to preheat said energy transfer media prior to entry into said thermal energy storage module.

4. The system of claim 1 wherein said turbine is a steam turbine and said energy transfer media is water that undergoes phase change during the process of providing electrical output.

5. The system of claim 1 wherein said turbine is a gas turbine and said energy transfer media is ambient air that does not undergo phase change during the process of providing electrical output.

6. The system of claim 5 further comprising:
a compressor driven by said turbine that compresses said energy transfer media and feeds said compressed energy transfer media to said recuperator where waste heat extracted from said exhaust heats said compressed gas that is fed to said thermal storage module, said turbine that is a gas turbine.

7. The system of claim 6 wherein said energy transfer media does not undergo phase change during the process of providing electrical output, is chosen from the group consisting of carbon dioxide, nitrogen, and helium.

8. The system of claim 6 further comprising:
a gas cooler located between said recuperator and said compressor;

9. The system of claim 1 wherein said source energy input is chosen from the group consisting of an electric resistance heater, solar energy, wind energy, geothermal energy, microwave energy, waste heat, chemical energy, fuel cell energy, and nuclear energy.

10. The system of claim 1 wherein said thermal energy storage media contains a salt.

11. The system of claim 1 wherein said thermal energy storage media is a mixture of sodium chloride and magnesium chloride.

12. The system of claim 1 wherein said thermal energy storage media is a compound with a melting point above 350 degrees C.

13. The system of claim 1 wherein said thermal conductive media is a plurality of loosely packed, randomly oriented conductive objects.

14. The system of claim 13 wherein at least a portion of said conductive objects are chosen from the group consisting of granular silicon carbide, metallic rods, metallic spheres, and non-woven metallic fibers.

15. The system of claim 1 wherein said thermal conductive media comprises a conductive geometric structure.

16. A system that stores thermal energy and provides electrical output comprising:
a primary thermal energy storage module comprising:
a first insulated containment vessel;
a first source energy input in thermal communication with a first thermal energy storage media and a first thermal conductive matrix, said first thermal conductive matrix that absorbs heat energy from said first source energy and conducts said heat energy throughout said first thermal conductive matrix in a first time period, said first thermal energy storage media that absorbs heat energy from said first source energy and said first thermal conductive matrix to produce a phase change in said first thermal energy storage media and store said heat energy as sensible heat and latent heat in a liquid form in said first time period; and,
a first heat exchanger in thermal communication with said first thermal energy storage media and said first thermal conductive matrix that transfers stored thermal energy in the form of sensible heat from said first thermal conductive matrix to a first energy transfer media in a second time period, said first thermal energy storage media that transfers stored thermal energy in the form of latent heat from the phase change of said first thermal energy storage media, and sensible heat from said first thermal energy storage media, to said first energy transfer media in said second time period;
a stored energy output in thermal communication with said energy transfer media that facilitates transport of said energy transfer media from said primary thermal energy storage module to a high pressure turbine, said high pressure turbine that converts said heat energy from said energy transfer media into primary work and primary exhaust;
a secondary thermal energy storage module comprising:
a second insulated containment vessel;
a second source energy input in thermal communication with a second thermal energy storage media and a second thermal conductive matrix, said second thermal conductive matrix that absorbs heat energy from said primary exhaust and conducts said heat energy throughout said second thermal conductive matrix in a first time period, said second thermal energy storage media that absorbs heat energy from said primary exhaust and said second thermal conductive matrix to produce a phase change in said second thermal energy storage media and store said heat energy as sensible heat and latent heat in a liquid form in said first time period; and,
a second heat exchanger in thermal communication with said second thermal energy storage media and said second thermal conductive matrix that transfers stored thermal energy in the form of sensible heat from said second thermal conductive matrix to a second energy transfer media in a second time period, said second thermal energy storage media that transfers stored thermal energy in the form of latent heat from the phase change of said second thermal energy storage media, and sensible heat from said second thermal energy storage media, to said second energy transfer media in said second time period;
a second stored energy output in thermal communication with said energy transfer media that facilitates transport of said energy transfer media from said secondary thermal energy storage module to a low pressure turbine, said low pressure turbine that converts said heat energy from said energy transfer media into secondary work and secondary exhaust;
a generator in mechanical communication with said high pressure turbine and low pressure turbine that utilizes said primary work and said secondary work to provide electricity in said second time period; and,
a recuperator in thermal communication with said secondary exhaust that extracts waste heat from said secondary exhaust to preheat said energy transfer media before returning said energy transfer media to said source energy input.

17. The system of claim 16 wherein said a first insulated containment vessel and said second insulated containment vessel are combined into a single apparatus.

18. The system of claim 16 further comprising:
a condenser located downstream of said recuperator that reduces the temperature of said energy transfer media;
a energy transfer media reservoir located downstream of said condenser;
a feed pump that pumps said energy transfer media to said primary thermal energy storage module via said recuperator.

19. The system of claim 18 further comprising:
a feedwater heater located between said recuperator and said primary thermal storage module;
a valve structure to optionally direct a portion of said energy transfer media from said primary thermal energy storage module to said feedwater heater to preheat said energy transfer media prior to entry into said primary thermal energy storage module.

20. The system of claim 16 wherein said energy transfer media is water that undergoes phase change during the process of providing electrical output.

21. The system of claim 16 wherein said source energy input is chosen from the group consisting of an electric resistance heater, solar energy, wind energy, geothermal energy, microwave energy, waste heat, chemical energy, fuel cell energy, and nuclear energy.

22. The system of claim 16 wherein said thermal energy storage media contains a salt.

23. The system of claim 16 wherein said thermal energy storage media is a mixture of sodium chloride and magnesium chloride.

24. The system of claim 16 wherein said thermal energy storage media is a compound with a melting point above 350 degrees C.

25. The system of claim 16 wherein said thermal conductive media is a plurality of loosely packed, randomly oriented conductive objects.

26. The system of claim 25 wherein at least a portion of said conductive objects are chosen from the group consisting of granular silicon carbide, metallic rods, metallic spheres, and non-woven metallic fibers.

27. A method of storing thermal energy and providing electrical energy output comprising the steps of:
during a first time period;
transferring thermal energy within an insulated containment vessel from a heat source to a thermal conductive matrix and a thermal energy storage media;
absorbing and conducting said thermal energy from said heat source throughout said thermal conductive matrix;
absorbing said thermal energy from said heat source and said thermal conductive matrix with a thermal storage media;
changing the phase of said thermal storage media from solid to liquid with said thermal energy; and,
storing said thermal energy in the form of sensible heat in said thermal conductive matrix, and storing said thermal energy in the form of sensible heat and latent heat in said liquefied thermal storage media;
during a second time period;
transferring said stored thermal energy in the form of sensible heat from said thermal conductive matrix through a heat exchanger to an energy transfer media;
transferring said stored thermal energy in the form of latent heat from the phase change of said thermal energy storage media, and sensible heat from said thermal energy storage media through said heat exchanger to said energy transfer media;
transferring thermal energy with said energy transfer media from said insulated containment vessel to a turbine;
converting said thermal energy from said energy transfer media into work and exhaust;
utilizing said work to provide electricity with a generator in mechanical communication with said turbine;
extracting waste heat from said exhaust with a recuperator;
preheating said energy transfer media with said extracted waste heat in said recuperator; and,
returning said energy transfer media to said insulated containment vessel.

28. The method of claim 27 wherein said steps of said first time period are performed concurrent with said steps of second time period.

29. The method of claim 27 further comprising the steps:
condensing said energy transfer media downstream of said recuperator;
receiving and storing said energy transfer media downstream of said condenser;
pumping said energy transfer media to said thermal energy storage module via said recuperator.

30. The method of claim 27 further comprising the steps:
transferring heat from a first portion of said energy transfer media exiting said turbine to a feedwater heater;
heating a second portion of said energy transfer media entering said thermal storage module with said feedwater heater located between said recuperator and said thermal storage module.

31. The method of claim 27 wherein said turbine is a steam turbine and said energy transfer media is water that undergoes phase change during the process of providing electrical output.

32. The system of claim 27 wherein said turbine is a gas turbine and said energy transfer media is ambient air that does not undergo phase change during the process of providing electrical output.

33. The method of claim 27 further comprising:
compressing said energy transfer media as a gas with the energy output of said turbine;
transferring said compressed energy transfer media to said recuperator;
extracting waste heat from said exhaust;
transferring said waste heat from said exhaust to said compressed gas that is input to said thermal storage module.

34. The method of claim 33 further comprising:
cooling said energy transfer media with a gas cooler located between said recuperator and said compressor.

35. The method of claim 27 further comprising:
providing said source energy input chosen from the group consisting of an electric resistance heater, solar energy, wind energy, geothermal energy, microwave energy, waste heat, chemical energy, fuel cell energy, and nuclear energy.

36. The method of claim 27 further comprising:
providing said thermal energy storage media contains a salt.

37. The method of claim 27 further comprising:
providing said thermal energy storage media as a mixture of sodium chloride and magnesium chloride.

38. The method of claim 27 further comprising:
providing said thermal energy storage media as a compound with a melting point above 350 degrees C.

39. The method of claim 27 further comprising:
providing said thermal conductive media as a plurality of loosely packed, randomly oriented conductive objects.

40. The method of claim 27 further comprising:
providing said conductive objects in a form chosen from the group consisting of granular silicon carbide, metallic rods, metallic spheres, and non-woven metallic fibers.

41. A system for storing thermal energy and providing electrical energy output comprising:
during a first time period;
a means for transferring thermal energy within an insulated containment vessel from a heat source to a thermal conductive matrix and a thermal energy storage media;
a means for absorbing and conducting said thermal energy from said heat source throughout said thermal conductive matrix;
a means for absorbing said thermal energy from said heat source and said thermal conductive matrix with a thermal storage media;
a means for changing the phase of said thermal storage media from solid to liquid with said thermal energy; and,
a means for storing said thermal energy in the form of sensible heat in said thermal conductive matrix, and storing said thermal energy in the form of sensible heat and latent heat in said liquefied thermal storage media;
during a second time period;
a means for transferring said stored thermal energy in the form of sensible heat from said thermal conductive matrix through a heat exchanger to an energy transfer media;
a means for transferring said stored thermal energy in the form of latent heat from the phase change of said thermal energy storage media, and sensible heat from said thermal energy storage media through said heat exchanger to said energy transfer media;
a means for transferring thermal energy with said energy transfer media from said insulated containment vessel to a turbine;
a means for converting said thermal energy from said energy transfer media into work and exhaust;
a means for utilizing said work to provide electricity with a generator in mechanical communication with said turbine;
a means for extracting waste heat from said exhaust with a recuperator;
a means for preheating said energy transfer media with said extracted waste heat in said recuperator; and,
a means for returning said energy transfer media to said insulated containment vessel.
